(19) United States
(12) Patent Application Publication
(10) Pub. No.: US 2012/0258354 A1
(43) Pub. Date: Oct. 11, 2012

(54) PACKAGING FOR ELECTROCHEMICAL DEVICE, AND ELECTROCHEMICAL DEVICE

(75) Inventors: Shigeyasu Yamaguchi, Ichihara-shi (JP); Osamu Nakayama, Minato-Ku (JP); Takashi Okuno, Minato-Ku (JP)

(73) Assignee: UBE INDUSTRIES LTD, YAMAGUCHI (JP)

(21) Appl. No.: 13/518,622

(22) PCT Filed: Dec. 24, 2010
(86) PCT No.: PCT/JP2010/073337

§ 371 Date: Jun. 22, 2012

(30) Foreign Application Priority Data
Dec. 25, 2009 (JP) 2009-296253

(51) Int. Cl. H01M 2/02; H01M 2/08

(52) U.S. Cl. 429/176; 429/185; 29/623.2

(57) ABSTRACT

Disclosed are a packaging for an electrochemical device such as a battery, and an electrochemical device using the packaging; the packaging being usable even under a severe condition such as a high temperature or a low temperature. The electrochemical device is produced by hermetically housing electrochemical device element 31 inside packaging 33 by using a laminate with a metal layer and a thermo-compression bondable polyimide layer so that a hermetically packed structure is formed by fusing the thermo-compression bondable polyimide layer at a periphery of the laminate.

### TECHNICAL FIELD

The present invention relates to a packaging for an electrochemical device such as a battery, and an electrochemical device having excellent durability and heat resistance with a simple configuration.

### BACKGROUND ART

There has been proposed a variety of primary batteries and secondary batteries as a power source of portable electronic devices in the past. Among them, lithium ion secondary batteries are intensively used due to its energy density and power density.

Non-aqueous electrolyte secondary batteries such as a lithium ion secondary battery have an outer casing of a metal can and a laminated film. Although a metal can is excellent in strength, the outer wall of the container is hard and flexibility of shape is small. Therefore, the shape and size of a hardware using the battery is defined by the shape of battery. In addition, a metal can is disadvantageous in terms of weight. In contrast, a laminated film is lightweight compared to a metal can, and a laminated film is advantageous in terms of price. There has been a number of proposals for batteries using a laminated film in the past (for example, Patent Documents 1 to 3).

Patent Document 1, for example, describes a battery having outer casing of an aluminum-laminated film. As shown in FIG. 17, this battery 1 is those produced by (i) laminating a positive electrode and a negative electrode interposing a separator between them and winding them to form a flattened shape, (ii) casing it in an aluminum-laminated film a battery element to which an electrolytic solution has been added, and (iii) sealing a periphery of the battery element. A positive electrode leading electrode 2a and a negative electrode leading electrode 2b, which have been connected to the positive electrode and the negative electrode, are taken outside the battery, for example, from one side of the battery 1. Usually, a bag form is formed by sealing at the periphery of the battery element except one side of the bag, and thereafter from the unsealed opening, the battery element is housed inside. Finally, the side from which leading electrode (for positive electrode) 2a and leading electrode (for negative electrode) 2b is sealed to give the battery.

In general, the aluminum-laminated film for this use has a structure of outer layer/adhesive layer/aluminum foil (metal layer)/adhesive layer/heat sealing layer from the outside. Herein, the aluminum foil has, in addition to a role of improving strength of the outer-casing material, a role to prevent the entering of water, oxygen and light to protect the contents of a battery. As the outer layer, there has been used a polyolefin, a polyamide, a polyimide and a polyester, specifically nylon (Ny), polyethylene terephthalate (PET), polyethylene (PE) and polyethylene naphthalate (PEN) due to their fineness of appearance, toughness, heat resistance, flexibility and the like.

The heat sealing layer of inner layers has thermal adhesiveness to enclose battery elements, and there has been used resins having a relatively low melting point such as polyethylene (PE), non-stretched polyethylene (CPE), non-stretched polypropylene (CPP), polyethylene terephthalate (PET), nylon (Ny), low density polyethylene (LDPE), high density polyethylene (HDPE), linear chain low density polyethylene (LLDPE) and the like.

For the adhesive layer, which sometimes may not be used, there has been used materials having a good adhesiveness with a metal such as acid-modified polyolefin, ionomer, ethylene vinyl acetate copolymer (EVA), ethylene acrylic acid copolymer and the like. In general, the adhesive layers have a melting point lower than that of the heat sealing layer, and these layers themselves may be used as the heat sealing layer.

In addition, since the heat sealing layer of inner layers contacts with an electrolytic solution, durability is needed against acids generated by the hydrolysis of the electrolytic solution and the electrolyte over a prolonged period. This is because if the heat sealing layer is deteriorated, the electrolyte solution erodes the aluminum foil, which enhances permeation of moisture from outside, leading to rapid deterioration of the electrolytic solution.

### PRIOR ART REFERENCES

### Patent Documents

Patent Document 1: JPA 2008-262803

Patent Document 2: JP A 2001-30407

Patent Document 3: JP A 2001-52748

### SUMMARY OF THE INVENTION

### Problems to be Solved by the Invention

In recent years, the use of non-aqueous electrolyte secondary batteries has been developed in a broader range of field, and the use under a severe conditions that has never been considered heretofore is also beginning to be studied.

However, the outer-casing with laminated film proposed to date have a certain limitation in heat resistance and durability, and hence there is a problem that applications of secondary batteries such as a lithium ion secondary battery have not been widened sufficiently. Furthermore, there is also a problem in safety because the film itself is flammable.

Hence, an objective of the present invention is to provide a packaging for an electrochemical device such as a battery, which is usable even under a severe condition such as a high temperature and/or a low temperature, and to provide an electrochemical device using the packaging.

### Means for Solving the Problems

The present invention relates to the following items.
1. A packaging for an electrochemical device, wherein
   the packaging is formed by using a laminate having a metal layer and a thermo-compression bondable polyimide layer, and
   the packaging is in a form of a hermetically packed structure in which the thermo-compression bondable polyimide layer is bonded by thermo-compression at a periphery of the laminate.
2. A packaging according to the above item 1, wherein the packaging is in a form of the hermetic structure such that the laminate is overlaid so that the thermo-compression bondable polyimide layer is placed inside and the thermo-compression bondable polyimide layer is bonded by thermo-compression at a periphery of the laminate.
3. A packaging according to the above item 2, wherein the hermetic structure is in a form of a hermetic bag structure or a hermetic tray structure.
4. A packaging according to any one of the above items 1 to 3, wherein the thermo-compression bondable polyimide layer is formed by a material capable of thermo-compression bonding within a range from 150° C. to 400° C.
5. A packaging according to any one of the above items 1 to 4, wherein the thermo-compression bondable polyimide layer comprising a multilayer structure including a thermo-compression bondable polyimide and a heat resistant polyimide.
6. A packaging according to the above item 5, wherein the heat resistant polyimide is a polyimide obtained from a combination comprising 3,3′,4,4′-biphenyltetracarboxylic dianhydride and p-phenylenediamine.
7. An electrochemical device comprising,
   the packaging according to any one of the above items 1 to 6, and
   an electrochemical device element hermetically housed inside of the packaging.
8. An electrochemical device according to the above item 7, which is a lithium ion secondary battery.
9. A method of producing an electrochemical device comprising an electrochemical device element and a packaging enclosing the electrochemical device element, the method comprising the steps of:
   providing a laminate having a metal layer and a thermo-compression bondable polyimide layer, and
   forming the packaging by heat-bonding the thermo-compression bondable polyimide layer of the laminate at a periphery to form a hermetically packed structure so that the electrochemical device element is housed inside.
10. A method of producing an electrochemical device according to the above item 9, wherein the packaging is formed into the hermetically packed structure by overlaying the laminate so that the thermo-compression bondable polyimide layer is placed inside, and performing thermo-compression bonding of the thermo-compression bondable polyimide layer at a periphery of the laminate.
11. A method of producing an electrochemical device according to the above item 10, wherein the packaging is formed so that the hermetically packed structure is in a form of a hermetic bag structure or a hermetic tray structure.
12. A method of producing an electrochemical device according to any one of the above items 9 to 11, comprising performing thermo-compression bonding the thermo-compression bondable polyimide layer by applying pressure while heating in a range from 150° C. to 400° C.

### EFFECT OF THE INVENTION

According to the present invention, there is provided a packaging for an electrochemical device such as a battery, which is usable even under a severe condition such as a high temperature and/or a low temperature. In particular, since the layer(s) inside the metal layer are formed of all polyimide, the packaging for an electrochemical device is extremely excellent in heat resistance and durability.

### BRIEF DESCRIPTION OF THE DRAWINGS

FIG. 1 is a drawing for illustrating an example of the structure of the laminate constituting the packaging.

FIG. 2 is a drawing for illustrating an example of the structure of the laminate constituting the packaging.

FIG. 3 is a drawing for illustrating an example of the structure of the laminate constituting the packaging.

FIG. 4 is a drawing for illustrating a step in an example of the method for forming the packaging from the laminate.

FIG. 5 is a drawing for illustrating a step in an example of the method for forming the packaging from the laminate.

FIG. 6 is a drawing for illustrating a step in an example of the method for forming the packaging from the laminate.

FIG. 7 is a drawing for illustrating a step in an example of the method for forming the packaging from the laminate and an example of the packaging (in a form of bag).

FIG. 8 is a drawing for illustrating an example of the packaging.

FIG. 9 is a drawing for illustrating an example of the packaging.

FIG. 10 is a drawing for illustrating an example of the packaging.

FIG. 11 is a drawing for illustrating an example of the packaging in a tray-shaped structure.

FIG. 12 is a drawing for illustrating a step in an example of the method for forming the packaging with a tray-shaped structure.

FIG. 13 is a drawing for illustrating a step in an example of the method for forming the packaging with a tray-shaped structure and the packaging (in a form of tray).

FIG. 14 is a drawing for illustrating an example of the packaging.

FIG. 15 is a drawing for illustrating an example of the packaging.

FIG. 16 is a drawing for illustrating an example of the multi-tray-shaped packaging and the production method thereof.

FIG. 17 shows the conventional battery structure.

### EMBODIMENT FOR CARRYING OUT THE INVENTION

### <<Structure of the Laminate Constituting the Packaging>>

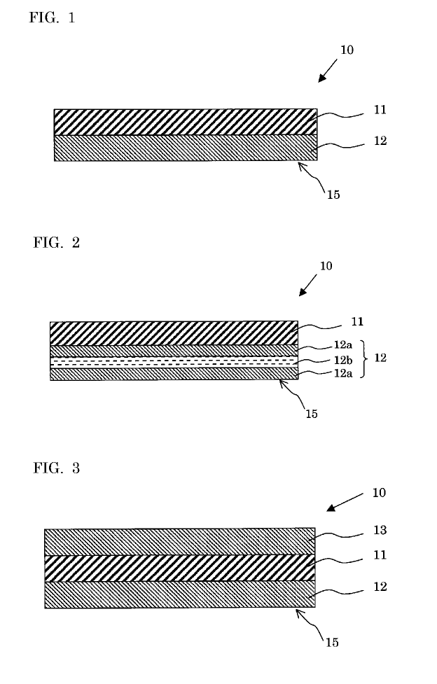

As shown in FIG. 1, the packaging of the present invention is formed from the laminate 10 comprising at least metal layer 11 and thermo-compression bondable polyimide layer 12.

The material of the metal layer 11 includes, but not particularly limited, aluminum, stainless steel, iron with Ni plating and the like. Preference is given to aluminum. Although the metal layer may be formed by vapor deposition and the like, a metal foil is usually used. The thickness of the metal layer is, but not particularly limited, for example, from 1 to 1,000 μm, preferably from 8 to 100 μm and more preferably from 20 to 100 μm. When retention of shape is intended, larger thickness is preferred, and is, for example, from 200 to 500 μm.

For the thermo-compression bondable polyimide layer 12, the entire layer 12 is formed of polyimide and at least surface 15 which becomes the inner surface of the packaging has thermo-compression bondability. Therefore, the entire layer 12 may be in a form of a single layer of the thermo-compression bondable polyimide, or it may be in a laminate structure having two or more layers of the thermo-compression bondable polyimide and a heat resistant polyimide (that is to say, a polyimide which does not soften at a temperature of compression bonding). FIG. 2 is an example of the thermo-compression bondable polyimide layer 12 having three-layer structure, in which thermo-compression bondable polyimide 12a is formed on both sides of heat resistant polyimide 12b. When layer 12 is constituted in multilayer, a boundary between each layer may be definite or may be a gradient layer where compositions are mixed.

While the thickness of the thermo-compression bondable polyimide layer 12 is not particularly limited, it is, for example, from 5 to 100 μm, preferably from 12.5 to 50 μm.

As shown in FIG. 3, the laminate may also have outer layer 13 outside metal layer 11. As the outer layer, known materials such as nylon explained in Background Art maybe used, but it may also be a polyimide layer. For example, outer layer 13 may be formed of the same material as the thermo-compression bondable polyimide layer 12. When the outer layer is formed from a multi-layer polyimide for example, it may be a three-layer structure of thermo-compression bondable polyimide/heat resistant polyimide/thermo-compression bondable polyimide as layer 12 in FIG. 2, or it may be a two-layer structure of thermo-compression bondable polyimide/heat resistant polyimide from the metal layer side.

When flame retardancy is demanded for the packaging, it is also preferred to use a polyimide, furthermore a polyimide excellent in flame retardancy as the material of thermo-compression bondable polyimide layer 12 and/or outer layer 13. As mentioned later, there is also a problem in that the conventional outer layer materials such as nylon melt by heat applied when inner layers (thermo-compression bondable polyimide layers) are bonded each other.

### <<Method of Producing the Laminate>>

Next, the method of producing the laminate to be used for the packaging of the present invention will be explained.

Initially, explained is the method of producing an embodiment wherein as shown in FIG. 2 the thermo-compression bondable polyimide layer has a three-layer structure of thermo-compression bondable polyimide/heat resistant polyimide/thermo-compression bondable polyimide and is laminated on the both sides of the metal layer. When referring to a layer formed of thermo-compression bondable polyimide in a multi-layer structure, the layer is referred as the thermo-compression bondable polyimide (Layer a), which is distinguished from the entire thermo-compression bondable polyimide layer 12. In addition, a layer formed of heat resistant polyimide in a multi-layer structure is referred as the heat resistant polyimide (Layer b).

As the heat resistant polyimide of the heat resistant polyimide (Layer b), there can be used those having at least one of the characteristics described below, those having at least two of the characteristics described below [combination of 1) and 2), 1) and 3), or 2) and 3)], or in particular those having all the characteristics described below.
1) As a single polyimide film, those with a glass transition temperature not less than 300° C., preferably a glass transition temperature not less than 330° C. and more preferably impossible to identify.
2) As a single polyimide film, those wherein its linear expansion coefficient (50 to 200° C.) (MD) should be close to a thermal expansion coefficient of a metal foil to be laminated on a heat resistant resin substrate.
3) As a single polyimide film, those with a tensile modulus (MD, ASTM-D882) not less than 300 kg/mm², preferably not less than 500 kg/mm² and furthermore not less than 700 kg/mm².

As the heat resistant polyimide, there can be used polyimide obtained from the combination of
(1) an acid component containing at least one selected from 3,3′4,4′-biphenyltetracarboxylic dianhydride, pyromellitic dianhydride and 1,4-hydroquinone dibenzoate-3,3′,4,4′-tetracarboxylic dianhydride, and preferably an acid component containing these acid components in an amount of at least not less than 70 mole %, further preferably not less than 80 mole % and more preferably not less than 90 mole %; and
(2) diamine component containing at least one selected from p-phenylene diamine, 4,4′-diaminodiphenyl ether, 3,4′-diaminodiphenyl ether, m-tolidine and 4,4′-diamino benzanilide, and preferably a diamine component containing these diamine components in an amount of at least not less than 70 mole %, further preferably not less than 80 mole % and more preferably not less than 90 mole %.

Preferable examples of the combination of the acid component and the diamine component constituting the heat resistant polyimide include
1) 3,3′,4,4′-bip he nyltetracarboxylic di anhydride(s-BPDA), and p-phenylenediamine(PPD) and optionally 4,4′-diaminodiphenyl ether(DADE), wherein PPD/DADE(molar ratio) is preferably from 100/0 to 85/15;
2) 3,3′,4,4′-biphenyltetracarboxylic dianhydride and pyromellitic dianhydride(PMDA), and p-phenylenediamine and optionally 4,4′-diaminodiphenyl ether, wherein BPDA/PMDA is preferably 0/100 to 90/10, and in case both PPD and DADE are used, PPD/DADE is preferably, for example, 90/10 to 10/90;
3) pyromellitic dianhydride, and p-phenylenediamine and 4,4′-diaminodiphenyl ether, wherein DADE/PPD is preferably 90/10 to 10/90; and
4) 3,3′,4,4′-biphenyltetracarboxylic dianhydride and p-phenylene diamine, as main ingredient components (not less than 50 mole % in the total 100 mole %).

The above combination 1) is preferred since it is particularly excellent in heat resistance.

In the above 1) to 4), part or all of 4,4′-diaminodiphenyl ether (DADE) may be replaced with 3,4′-diaminodiphenyl ether or another diamine described later.

These are used as materials of electronic parts such as printed wiring boards, flexible printed circuit boards, TAB tapes and the like, and they are preferred because they have excellent mechanical properties over a wide temperature range, long-term heat resistance, excellent resistance to hydrolysis, a high heat decomposition initiation temperature, small heat shrinkage ratio and linear expansion coefficient, and excellent flame retardancy.

As the acid component that may be used for obtaining the heat resistant polyimide, in addition to the acid components illustrated above, there can be used an acid dianhydride component such as 2,3,3′,4′-biphenyltetracarboxylic dianhydride, 3,3′,4,4′-benzophenonetetracarboxylic dianhydride, bis(3,4-dicarboxyphenyl)ether dianhydride, bis(3,4-dicarboxyphenypsulfide dianhydride, bis(3,4-dicarboxyphenyl)sulfone dianhydride, bis(3,4-dicarboxyphenyl)methane dianhydride, 2,2-bis(3,4-dicarboxyphenyl)propanedianhydride, 2,2-bis(3,4-dicarboxyphenyl) 1,1,1,3,3,3-hexafluoroprop ane dianhydride, 2,2-bis[(3,4-dicarboxyphenoxy)phenyl]propane dianhydride or the like, in the ranges in which the characteristics of the present invention are not impaired.

As the diamine component that may be used for obtaining the heat resistant polyimide, in addition to the diamine components illustrated above, there can be used a diamine component such as m-phenylene diamine, 2,4-toluene diamine, 3,3′-diaminodiphenyl sulfide, 3,4′-diaminodiphenyl sulfide, 4, 4′-diaminodip henyl sulfide, 3,3′-diaminodiphenyl sulfone, 3,4′-diaminodiphenyl sulfone, 4,4′-diaminodiphenyl sulfone, 3,3′-diaminobenzophenone, 4,4′-diaminobenzophenone, 3,4′-diaminobenzophenone, 3,3′-diaminodiphenyl methane, 4,4′-diaminodiphenyl methane, 3,4′-diaminodiphenyl methane, 2,2-di(3-aminophenyl)propane, 2,2-di(4-aminophenyl)propane, bis(aminophenoxy) benzenes such as 1,3-bis(4-aminophenoxy) benzene, 1,4-bis(4-aminophenoxy) benzene, 1,3-bis(3-aminophenoxy)benzene, 1,4-bis(3-aminophenoxy) benzene, 2,2-bis [4-(4-aminophenoxy)phenyl]propane, 4,4′-bis(4-aminophenoxy)biphenyl and the like, in the ranges in which the characteristics of the present invention are not impaired.

As thermo-compression bondable polyimide or thermo-compression bondable polyimide layer (layer a), known polyimides having a property capable of thermo-compression bonding to metal foils such as copper foil and aluminum foil are used.

The thermo-compression bondable polyimides are those that can be laminated with a metal foil at a temperature equal to or higher than the glass transition temperature of the thermo-compression bondable polyimides, preferably in a range from a temperature higher than a glass transition temperature by 20° C., more preferably in a range from a temperature higher than a glass transition temperature by 30° C., and particularly preferably in a range from a temperature higher than a glass transition temperature by 50° C., each up to 400° C. or lower.

As the thermo-compression bondable polyimide, there can be used those having at least one property below, those having at least two properties below {i.e., the combination of 1) and 2); 1) and 3); or 2) and 3)}, those having at least three properties below {i.e., the combination of 1), 2) and 3); 1), 3) and 4); 2), 3) and 4); 1), 2)and 4); or the like}, and particularly those having all properties below:
1) the thermo-compression bondable polyimide layer (layer a) has a peel strength with the metal foil of 0.7 N/mm or more, and the retention ratio of a peel strength after heat treatment at 150° C. for 168 hours is 90% or more, further 95% or more and particularly 100% or more;
2) its glass transition temperature is from 130 to 330° C., or those that can be thermo-compression bondable between the thermo-compression bondable polyimides or between the thermo-compression bondable polyimide and a metal foil at 150° C. to 400° C., preferably 250° C. to 370° C.;
3) its tensile modulus is from 100 to 700 Kg/mm²; and
4) its linear expansion coefficient (50 to 200° C.) (MD) is from 13×10⁻⁶ to 30×10⁻⁶ cm/cm/° C.

The thermo-compression bondable polyimide (Layer a) is preferably selected from those that can perform thermo-compression bonding of the thermo-compression bondable polyimides (Layers a) each other and thermo-compression bonding of the thermo-compression bondable polyimide (Layer a) and the leading electrodes of an electrochemical device within a range from 250° C. or higher to 400° C. or lower, preferably from 270° C. to 370° C. This enables a packaging having an excellent heat resistance which is usable under a high temperature

As a thermo-compression bondable polyimide, there can be used polyimide obtained from:
(1) an acid component containing at least one component selected from acid dianhydrides such as 3,3′,4,4′-biphenyltetracarboxylic dianhydride, 2,3,3′,4′-biphenyltetracarboxylic dianhydride, pyromellitic dianhydride, 3,3′,4,4′-benzophenonetetracarboxylic dianhydride, bis(3,4-dicarboxyphenypether dianhydride, bis(3,4-dicarboxyphenypsulfide dianhydride, bis(3,4-dicarboxyphenyl)sulfone dianhydride, bis(3,4-dicarboxyphenyl)methane dianhydride, 2,2-bis(3,4-dicarboxyphenyppropane dianhydride, 1,4-hydroquinone dibenzoate-3,3′,4,4′-tetracarboxylic dianhydride and the like, and preferably an acid component containing these acid components in an amount of at least not less than 70 mole %, further preferably not less than 80 mole % and more preferably not less than 90 mole %, and
(2) a diamine component containing at least one component selected from diamines such as 1,3-bis(4-aminophenoxy)benzene, 1,3-bis(3-aminophenoxy)benzene, 1,4-bis(4-aminophenoxy)benzene, 3,3′-diaminobenzophenone, 4,4′-bis(3-aminophenoxy)biphenyl, 4,4′-bis(4-aminophenoxy)biphenyl, bis [4-(3-aminophenoxy)phenyl]ketone, bis [4-(4-aminophenoxy)phenyl]ketone, bis [4-(3-aminophenoxy)phenyl]sulfide, bis [4-(4-aminophenoxy)phenyl]sulfide, bis [4-(3-aminophenoxy)phenyl]sulfone bis [4-(4-aminophenoxy)phenyl]sulfone, bis [4-(3-aminophenoxy)phenyl]ether, bis [4-(4-aminophenoxy)phenyl]ether, 2,2-bis [4-(3-aminophenoxy)phenyl]propane, 2,2-bis [4-(4-aminophenoxy)phenyl]propane and the like as a diamine component, and preferably a diamine component containing these diamine components in an amount of at least not less than 70 mole %, further preferably not less than 80 mole % and more preferably not less than 90 mole %.

As the combination of the acid component and the diamine component that can be used for obtaining the thermo-compression bondable polyimide, there can be used polyimide obtained from:
(1) an acid component containing at least one component selected from acid dianhydrides such as 3,3′,4,4′-biphenyltetracarboxylic dianhydride and 2,3,3′,4′-biphenyltetracarboxylic dianhydride, and preferably an acid component containing these acid components in an amount of at least not less than 70 mole %, further preferably not less than 80 mole % and more preferably not less than 90 mole %; and
(2) a diamine component containing at least one component selected from diamines such as 1,3-bis(4-aminophenoxy)benzene, 1,3-bis(3-aminophenoxy)benzene, 4,4′-bis(3-aminophenoxy)biphenyl, bis[4-(3-aminophenoxy)phenyl]sulfone, bis [4-(3-aminophenoxy)phenyl]ether, 2,2-bis [4-(3-aminophenoxy)phenyl]propane, 2,2-bis[4-(4-aminophenoxy)phenyl]propane and the like as a diamine component, and preferably a diamine component containing these diamine components in an amount of at least not less than 70 mole %, further preferably not less than 80 mole % and more preferably not less than 90 mole %.

As the diamine component that may be used for obtaining the thermo-compression bondable polyimide, in addition to the diamine components illustrated above, there can be used a diamine component such as p-phenylene diamine, m-phenylene diamine, 2,4-toluene diamine, 3,4′-diaminodiphenyl ether, 3,3′-diaminodiphenyl sulfide, 3,4′-diaminodiphenyl sulfide, 4,4′-diaminodiphenyl sulfide, 3,3′-diaminodiphenyl sulfone, 3,4′-diaminodiphenyl sulfone, 4, 4′-diaminodiphenyl sulfone, 3,3′-diaminobenzophenone, 4,4′-diaminobenzophenone, 3,4′-diaminobenzophenone, 3,3′-diaminodiphenyl methane, 4,4′-diaminodiphenyl methane, 3,4′-diaminodiphenyl methane, 2,2-di(3-aminophenyl)propane, 2,2-di(4-aminophenyl)propane and the like, in the ranges in which the characteristics of the present invention are not impaired.

A polyimide precursor may be synthesized by known methods, for example, by random-polymerizing or block-polymerizing substantially equimolar amounts of an acid component such as an aromatic tetracarboxylic dianhydride and an diamine component in an organic solvent. Alternatively, two or more polyimide precursors in which either of these two components is excessive may be prepared, and subsequently, these polyimide precursor solutions may be combined and then mixed under reaction conditions. The polyimide precursor solution thus obtained may be used without any treatment, or may be used after removing or adding a solvent, if necessary, for the preparation of a self-supporting film.

Furthermore, in the case that polyimide having an excellent solubility is used, the organic solvent solution of the polyimide can be obtained by heating the polyimide precursor solution at 150 to 250° C., or adding an imidization agent to perform reaction at not more than 150° C., particularly from 15 to 50° C., and followed by evaporating the solvent after imide-cyclizing, or followed by precipitation in a poor solvent to give powder, and dissolving the powder in the organic solution.

Examples of an organic solvent for the polyimide precursor solution include N-methyl-2-pyrrolidone, N,N-dimethylform amide, N,N-dimethylacetamide and N,N-diethylacetamide. These organic solvents may be used alone or in combination of two or more.

The polyimide precursor solution may contain an imidization catalyst, an organic phosphorous-containing compound, a fine particle such as an inorganic fine particle and an organic fine particle, and the like, if necessary.

Examples of the imidization catalyst include substituted or unsubstituted nitrogen-containing heterocyclic compounds, N-oxide compounds of the nitrogen-containing heterocyclic compounds, substituted or unsubstituted amino acid compounds, hydroxyl-containing aromatic hydrocarbon compounds, and aromatic heterocyclic compounds. Particularly preferable examples of the imidization catalyst include lower-alkyl imidazoles such as 1,2-dimethylimidazole, N-methylimidazole, N-benzyl-2-methylimidazole, 2-methylimidazole, 2-ethyl-4-methylimidazole and 5-methylbenzimidazole; benzimidazoles such as N-benzyl-2-methylimidazole; and substituted pyridines such as isoquinoline, 3,5-dimethylpyridine, 3,4-dimethylpyridine, 2,5-dimethylpyridine, 2,4-dimethylpyridine and 4-n-propylpyridine. The amount of the imidization catalyst to be used is preferably about 0.01 to 2 equivalents, particularly preferably about 0.02 to 1 equivalents relative to the amide acid unit in a polyamide acid. When the imidization catalyst is used, the polyimide film obtained may have improved properties, particularly extension and edge-cracking resistance.

When chemical imidization is intended, generally, a chemical imidization agent of the combination of a dehydration-ring closure agent and an organic amine is mixed in the polyimide precursor solution. The examples of dehydration-ring closure agent include, for example, dicyclohexylcarbodiimide and acid anhydride such as acetic anhydride, propionic anhydride, valeric anhydride, benzoic anhydride, trifluoroacetic anhydride; and the examples of organic amine include, for example, picoline, quinoline, isoquinoline, pyridine and the like; but not limited to these.

There are no particular restrictions to the polyimide precursor solution, so long as it may be cast on a support and converted into a self-supporting film which may be peeled from the support and be stretched in at least one direction. The kind, polymerization degree and concentration of the polymer, and the kind and concentration of an additive which may be added to the solution, if necessary, and the viscosity of the solution may be appropriately selected.

The concentration of the polyimide precursor in the polyimide precursor solution is preferably 5 to 30 mass %, more preferably 10 to 25 mass %, and further preferably 15 to 20 mass %. Viscosity of the polyimide precursor solution is preferably 100 to 10000 poise, more preferably 400 to 5000 poise, further preferably 1000 to 3000 poise.

The thermo-compression bondable film for forming the thermo-compression bondable polyimide layer 12 can be obtained preferably by a method (i) or (ii), i.e.
(i) by the coextrusion-flow-casting film formation method (also being simply referred to as multi-layer extrusion method), the dope liquid of the heat resistant polyimide layer (layer b) and the dope liquid of the thermo-compression bondable polyimide layer (layer a) are laminated, dried and imidized to obtain a multi-layer polyimide film, or
(ii) the dope liquid of the heat resistant polyimide layer (layer b) is flow-cast on a support, and dried to give a self-supporting film (gel film), and next, on one side or both sides thereof, the dope liquid of the thermo-compression bondable polyimide layer (layer a) is applied, dried and imidized to give a multi-layer polyimide film.

For the coextrusion method, there may be used a well-known method, for example, a method described in the Japanese Laid-open Patent Publication No. H03-180343 (Japanese Kokoku Patent Publication No. H07-102661).

An embodiment of the production of a three-layer thermo-compression bondable polyimide film having thermo-compression bonding properties on both sides is illustrated.

The solution of a polyamic acid for the heat resistant polyimide layer (layer b) and the solution of a polyamic acid for the thermo-compression bondable polyimide layer (layer a) are supplied to a three-layer extrusion molding die so that the thickness of the heat resistant polyimide layer (layer b) is 4 to 45 μm and the thickness of the thermo-compression bondable polyimide layer (layer a) on both sides is 3 to 10 μm in total, and by a three-layer coextrusion method this is flow-cast and applied on a support surface such as a stainless mirror surface and a stainless belt surface, and at 100 to 200° C., a self-supporting film can be obtained in a semi-cured state or a dried state before the semi-curing.

For the self-supporting film, if a flow-casted film is treated at a temperature higher than 200° C., some defects tend to occur such as decrease in adhesiveness during production of the polyimide film having thermo-compression bonding property. This semi-cured state or the state before the semi-curing means a self-supporting state by heating and/or chemical imidization.

The self-supporting film obtained is heated at a temperature of not lower than the glass transition temperature (Tg) of the thermo-compression bondable polyimide layer (layer a) and not higher than degradation-occurring temperature, preferably a temperature of from 250 to 420° C. (surface temperature measured by a surface thermometer) (preferably heating at this temperature for 0.1 to 60 minutes), dried and imidized. Thus, the polyimide film having the thermo-compression bondable polyimide layer (layer a) on both sides of the heat resistant polyimide layer (layer b) is produced.

In the self-supporting film obtained, a solvent and generated water remain preferably at about 20 to 60% by mass and particularly preferably from 30 to 50% by mass (i.e. heating loss is preferably about 20 to 60% by mass and particularly preferably from 30 to 50% by mass). This self-supporting film is preferably heated up for relatively short period when it is heated-up to a drying temperature. For example, a heating rate is preferably not less than 10° C./min. When drying, by increasing the tension applied to the self-supporting film, the linear expansion coefficient of the polyimide film thus finally obtained is reduced.

Then, following the above-mentioned drying step, the self-supporting film is continuously or intermittently dried and heat-treated, in a condition in which at least a pair of side edges of the self-supporting film is fixed by a fixing equipment capable of continuously or intermittently moving together with the self-supporting film, at a high temperature higher than the drying temperature, preferably within a range of 200 to 550° C. and particularly preferably within a range of 300 to 500° C. preferably for 1 to 100 minutes and particularly 1 to 10 minutes. The polyimide film having thermo-compression bonding property on both sides may be formed by sufficiently removing the solvent or the like from the self-supporting film and at the same time sufficiently imidizing the polymer consisting of the film so that the contents of volatile components consisting of organic solvents and generated water in the polyimide film to be finally obtained is preferably not more than 1 weight %.

The fixing equipment of the self-supporting film preferably used herein is, for example, equipped with a pair of belts or chains having a plurality of pins or holders at even intervals, along both side edges in the longitudinal direction of the solidified film supplied continuously or intermittently, and is able to fix the film while the pair of belts or chains are continuously or intermittently moved with movement of the film. In addition, the fixing equipment of the above solidified film may be able to extend or shrink the film under heat treatment with a suitable elongation percentage or shrinkage ratio in a lateral direction or a longitudinal direction (particularly preferably from about 0.5 to 5% of elongation percentage or shrinkage ratio).

Incidentally, the polyimide film having thermo-compression bonding property on both sides having particularly excellent dimensional stability may be obtained by heat-treating the polyimide film having thermo-compression bonding property on both sides produced in the above step again under low or no tension of preferably not higher than 4N and particularly preferably not higher than 3N at a temperature of 100 to 400° C. preferably for 0.1 to 30 minutes. In addition, the thus-produced lengthy polyimide film having thermo-compression bonding property on both sides may be rewound in a roll form by an appropriate known method.

The heating loss of the above self-supporting film refers to a value obtained by the following equation from the weight W1 measured before drying and the weight W2 measured after drying when the object film is dried at 420° C. for 20 minutes.

Heating Loss (% by mass)={(W1−W2)/W1}×100

Furthermore, the imide conversion ratio of the above self-supporting film is obtained by the method using a Karl Fischer's moisture meter as described in the Japanese Laid-open Patent Publication No. H09-316199.

A fine inorganic or organic additive may be added to the self-supporting film inside or surface layer thereof as needed. As the inorganic additive, there can be exemplified a particle-like or platelet-like inorganic filler. As the organic additive, there can be exemplified polyimide particles, particles of a thermosetting resin or the like. The amount and shape (size, aspect ratio) are preferably selected depending on the purpose of use.

Heating treatment can be performed by using various known equipments such as a hot air furnace, an infrared furnace or the like.

In the manner above, obtained is the double-sided thermo-compression bondable polyimide film having a structure of thermo-compression bondable polyimide (Layer a)/heat resistant polyimide (Layer b)/thermo-compression bondable polyimide (Layer a). Then, this double-sided thermo-compression bondable polyimide film (hereinafter simply referred to as the double-sided thermo-compression bondable film) is laminated on both sides of a metal foil such as aluminum foil.

When the metal foil and the thermo-compression bondable polyimide film are laminated, a heating machine, a compression machine and a thermo-compression machine may be used, and preferably a heating or compression condition is appropriately selected depending on materials to be used. Although the production process is not particularly limited as long as continuous or batch laminating is possible, it is preferably carried out continuously by using a roll laminator, a double-belt press or the like.

As an example of the method producing the laminate, the following method is exemplified. That is, a lengthy double-sided thermo-compression bondable film, a lengthy metal foil (length of 200 to 2,000 m) and a lengthy double-sided thermo-compression bondable film are piled in three layers in this order. They are preferably pre-heated at about 150 to 250° C., particularly at a temperature higher than 150° C. and 250° C. or lower for about 2 to 120 seconds in line immediately before introducing in the machine by using a pre-heater such as a hot-air blower or an infrared heating machine. By using a pair of compression-bonding rolls or a double-belt press, they are thermally bonded under pressure, wherein a temperature in a heating and compression-bonding zone of the compression-bonding rolls or the double-belt press is in a range from a temperature higher than a glass transition temperature by 20° C. or more of polyimide, further in a range from a temperature higher than a glass transition temperature by 30° C. or more, and particularly in a range from a temperature higher than a glass transition temperature by 50° C. or more, each up to 400° C. In particular, in the case of a double-belt press, the laminate is successively cooled while being pressed in a cooling zone. The laminate is suitably cooled to a temperature in a range from a temperature lower than the glass transition temperature of the polyimide by 20° C. or more, particularly by 30° C. or more, to 110° C., preferably to 115° C., more preferably to 120° C., and thus the lamination is completed, and the laminate is rewound in a roll form. Thus, the double-sided thermo-compression bondable films are laminated on both sides of the metal foil, and resultantly the laminate having thermo-compression bondable polyimide layers on both sides of a metal layer is obtained.

The pre-heating of the polyimide film before thermo-compression bonding is effective to prevent the occurrence of defective appearance due to foaming in the laminate after thermo-compression bonding.

The double-belt press can perform heating to high temperature and cooling down while applying pressure, and a hydrostatic type one using a heat carrier is preferable.

In the production of the laminate, lamination is carried out preferably at a drawing rate of 1 m/min or more by thermo-compression bonding and cooling under pressure using a double-belt press. Thus-obtained laminate is continuously long and has a width of about 400 mm or more, particularly about 500 mm or more, and high adhesion strength (the peel strength of the metal foil and the polyimide film is not less than 0.7 N/mm, and the holding ratio of the peel strength is not less than 90% after heating treatment at 150° C. for 168 hours), and further has good appearance so that substantially no wrinkles are observed on the metal foil surface.

In the production of the laminates, lamination may be carried out by thermo-compression bonding and cooling under pressure while placing protectors between outermost layers at both sides and the belts (i.e., two sheets of protectors).

For the protector, its material is not particularly limited for use as long as it is not thermo-compression bondable to the thermo-compression bondable polyimide layer 12 and metal layer 11 in the production of the laminates and has a good surface smoothness. The preferred examples thereof include metal foil, particularly copper foil, stainless foil, aluminum foil, and high heat resistant polyimide film (Upilex S, manufactured by Ube Industries, Ltd., Kapton H manufactured by DuPont-TORAY Co., Ltd.) and the like having about 5 to 125 μm in thickness, and preferably Upilex S.

The above explanation was made for the method in which the double-sided thermo-compression bondable polyimide film of {thermo-compression bondable PI (Layer a)/heat resistant PI (Layer b)/thermo-compression bondable PI (Layer a)} was formed and the laminate having a structure of {thermo-compression bondable PI (Layer a)/heat resistant PI (Layer b)/thermo-compression bondable PI (Layer a)}/metal layer/{thermo-compression bondable PI (Layer a)/heat resistant PI (Layer b)/thermo-compression bondable PI (Layer a)} was produced. In a similar manner, a two-layer structure film (a single-sided thermo-compression bondable polyimide film) of {thermo-compression bondable PI (Layer a)/heat resistant PI (Layer b)} and a {thermo-compression bondable PI (Layer a) single layer} structure film can be formed. By a combination of these films, laminates with the following structures can be produced. Nevertheless, these are illustrative examples and the structures of laminates are not limited to these.
{thermo-compression bondable PI (Layer a)/heat resistant PI (Layer b)/thermo-compression bondable PI (Layer a)}/metal layer/{thermo-compression bondable PI (Layer a)/heat resistant PI (Layer b)},
{thermo-compression bondable PI (Layer a)/heat resistant PI (Layer b)/thermo-compression bondable PI (Layer a)}/metal layer,
{thermo-compression bondable PI (Layer a) single layer}/metal layer/{thermo-compression bondable PI (Layer a)/heat resistant PI (Layer b)},
{thermo-compression bondable PI (Layer a) single layer}/metal layer,
{thermo-compression bondable PI (Layer a) single layer}/metal layer/{thermo-compression bondable PI (Layer a)/heat resistant PI (Layer b)/thermo-compression bondable PI (Layer a)}

The thermo-compression bondable polyimide layer may also be formed directly on a metal foil to become the metal layer in the laminate. Namely, the polyimide precursor solution prepared as mentioned above may be cast or applied on the metal foil, which is then imidized by heat treatment. The heat treatment condition for imidization may be similar condition to the condition for forming the film mentioned above.

Even when the thermo-compression bondable polyimide layer is formed directly on a metal foil, the thermo-compression bondable polyimide layer may be in a form of a single layer of the thermo-compression bondable polyimide, or may be in a form of multilayer. For a production method for a multilayer constitution, a method of casting and applying the polyimide precursor solution on a metal foil, for example by a multilayer extrusion method, may be used instead of casting and applying the polyimide precursor solution on a supporting substrate, as similar to case of forming a film including the thermo-compression bondable polyimide layer. After carrying out a similar treatment, a laminate having the structure of, for example, {thermo-compression bondable PI (Layer a)/heat resistant PI (Layer b)/thermo-compression bondable PI (Layer a)}/metal layer is also produced. The polyimide precursor solution may also be cast and applied on the both sides of a metal foil. By combining these, may be produced laminates having the same structure as those exemplified above for the laminates obtained by film-lamination.

### <<Packaging the an Electrochemical Device by the Laminate, and Packaging Configurations>>

Configurations of the packaging of the present invention (shapes after an electrochemical device element has been enclosed and sealed) is not particularly limited and various shapes are possible as long as the thermo-compression bondable polyimide layer is heat-sealed at a periphery to form a hermetically packed structure.

Firstly, an example of the packaging having bag structure is explained with reference to drawings. Explanation will be made to a lithium ion secondary battery as an example of electrochemical devices.

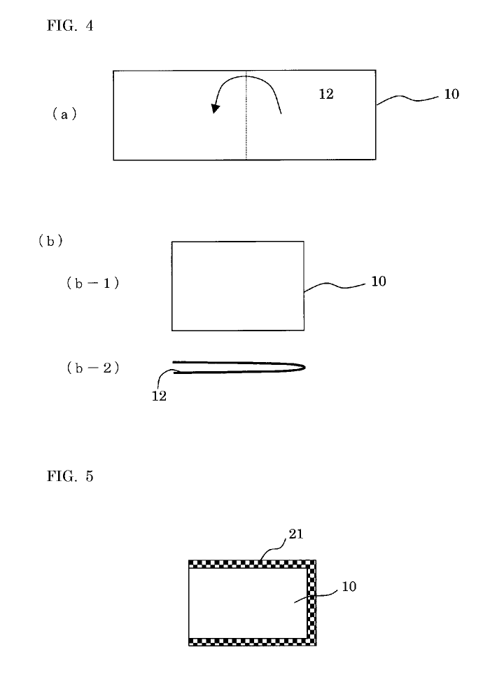

As shown in FIG. 4(a), laminate 10 is initially prepared, and as shown in FIG. 4(b) it is folded back so that thermo-compression bondable polyimide layer 12 is placed inside. The appearance of its folded state is shown in FIG. 4(b-1) as a plan view and in FIG. 4(b-2) as a cross sectional view.

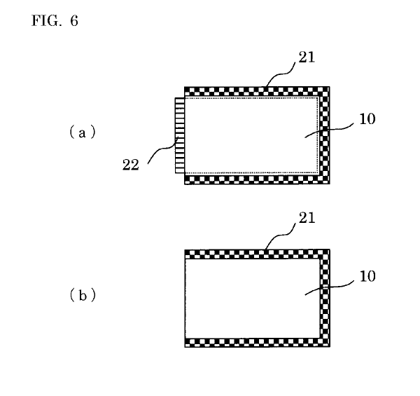

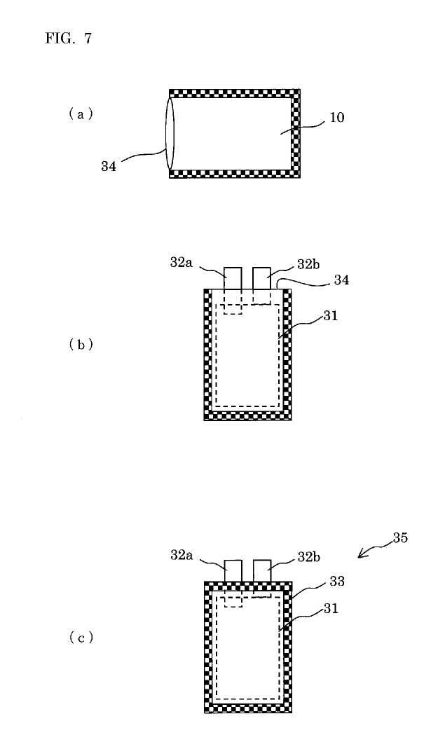

Then as shown in FIG. 5, thermo-compression bonded portion 21 is formed at three sides by thermo-compression bonding the three sides at a periphery of the folded laminate 10 to form a bag from the laminate. The thermo-compression bonding may be conducted by pressing a bonding portion while heating at a temperature where the surface of the thermo-compression bondable polyimide layer softens so that the thermo-compression bonding takes place, and for example, by pressing with use of a thermo-compression bonding fixture having an appropriate shape. Alternatively as shown in FIG. 6(a), utilizing spacer 22 such as a protective material which is not thermo-compression bondable to thermo-compression bondable polyimide layer 12, the laminates are overlaid each other at the three sides of the periphery while interleaving the spacer 22 at the central area including the remaining one side (left side in the figure). While keeping this state, the entirety is pressed and heated, whereby the three sides at the periphery where the laminates are overlaid each other are thermally fusion-bonded. After removing the spacer 22 off, as shown in FIG. 6(b), a bag having three sealed sides is formed.

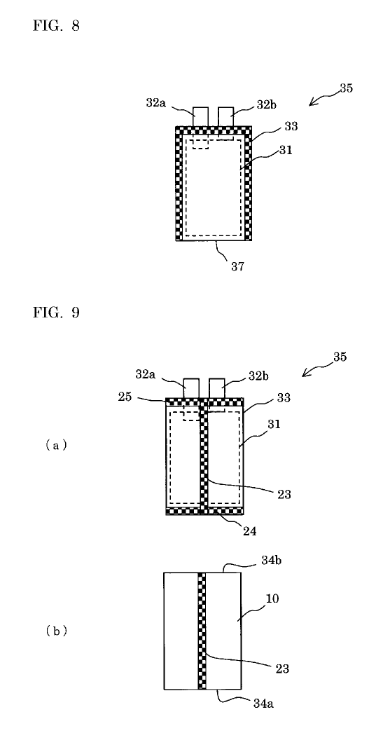

Into the laminate formed into the bag shape having an opening at one side as shown in FIG. 7(a), battery element 31 is placed from opening portion 34, while leading electrodes 32a and 32b are drawn outside the bag as shown in FIG. 7(b). As shown in FIG. 7(c), opening portion 34 is subjected to thermo-compression bonding, which causes bonding of the thermo-compression bondable polyimide layer by thermo-compression bonding, and hence, the opening is sealed with battery element 31 being enclosed. In this manner, formation of lithium ion secondary battery 35 having battery element 31 and packaging 33 is completed.

For the packaging, a hermetic bag structure is formed by thermo-compression bonding of the thermo-compression bondable polyimide layer at the periphery of the laminate. The thermo-compression bondable polyimide layer sticks firmly with the leading electrode at an area where the thermo-compression bonded portion intersects with the leading electrode, and the thermo-compression bondable polyimide layers are bonded (stuck firmly) each other at other thermo-compression bonded portions.

Herein, the battery element includes known battery-constituting elements such as a positive electrode, a negative electrode, an electrolytic solution or a solid electrolyte, and a separator.

A wide variety of structures is possible for the hermetic bag structure enclosing the battery element. Firstly, while the folded side has been also bonded with thermo-compression in the embodiment described above, the folded side 37 may not be bonded with thermo-compression as shown in FIG. 8. In addition, in place of folding back a single sheet of the laminate as shown in

FIG. 4, two sheets of laminate may be used and they are overlaid so that the thermo-compression bondable polyimide layers face each other, and may be bonded at a periphery by thermo-compression bonding.

The structure may also be in a pillow-shape, for example, as shown in FIG. 9(a). As shown in FIG. 9(b), in forming the pillow-shape, tubular shape is formed by overlapping a pair of opposite sides of a single sheet of rectangular laminate 10 to form thermo-compression bonded portion 23. Then, thermo-compression bonded portions 24 and 25 are formed individually by sequentially thermo-compression bonding opening portions 34a and 34b above and below in the figure, whereby the hermetic bag structure is made.

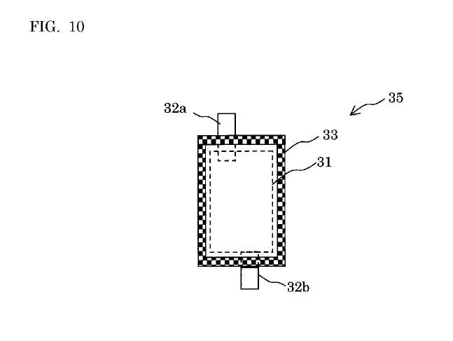

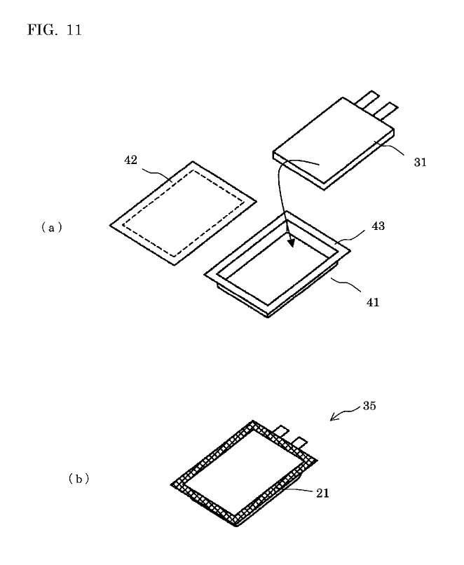

Furthermore, the leading electrode may be drawn in any manner. For example, the leading electrode 32a and the leading electrode 32b may be drawn from different sides as shown in FIG. 10.

The packaging of the present invention may also be in a tray-shape structure. For example as shown in FIG. 11(a), lower tray 41 that was formed by, for example, pressing laminate 10 and upper tray 42 (the laminate unprocessed into shape in this example) are prepared. Flange portion 43 is formed at a periphery of the lower tray 41 to make thermo-compression bonding easier, and the thermo-compression bondable polyimide layers are placed on the overlaying sides of both of the upper tray and the lower tray. After battery element 31 is placed into lower tray 41, the upper tray is overlaid and the periphery is bonded with thermo-compression to complete the formation of lithium ion secondary battery 35, in which its periphery has been hermetically closed at the thermo-compression bonded portion 21 as shown in FIG. 11(b). Herein, as the upper tray, a shaped article having a tray form like lower tray 41 may be used.

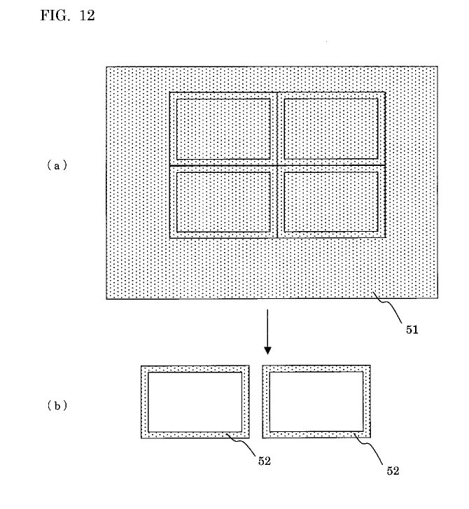

In the present invention, the packaging with a tray structure may be formed by methods other than a press molding method. Firstly as shown in FIG. 12(a), thermo-compression bondable polyimide film 51 is prepared. Although this polyimide film may be formed with a single layer of the thermo-compression bondable polyimide, the film is preferably a film having the above-mentioned structure of {thermo-compression bondable PI (Layer a)/heat resistant PI (Layer b)/thermo-compression bondable PI (Layer a)}. The film is cut to make a number of frame-like sheets 52 as shown in FIG. 12(b).

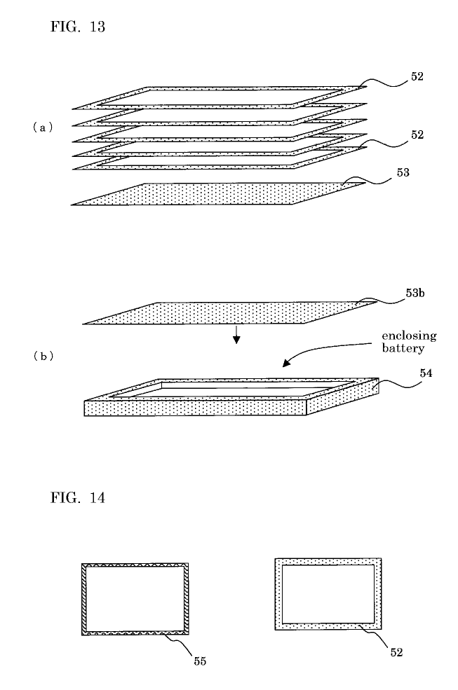

Next, from a laminate having a metal layer and a thermo-compression bondable polyimide layer, sheet 53 having a size almost the same as or slightly larger than the outer shape of frame-like sheet 52 is prepared. Then, a plurality of frame-like sheets 52 is stacked on a side of the thermo-compression bondable polyimide layer of sheet 53 as shown in FIG. 13(a), which is bonded with thermo-compression to produce tray 54 shown in FIG. 13(b). In a similar manner to the above-mentioned embodiment using the tray, a battery element is housed into the tray, and sheet 53b, which has been made from a laminate having a metal layer and a thermo-compression bondable polyimide layer, is overlaid so that the thermo-compression bondable polyimide layer is placed below and bonded with thermo-compression. Thus, completed is the formation of a lithium ion secondary battery housed in the packaging of which the periphery portion is hermetically closed by thermo-compression bonded portion of the thermo-compression bondable polyimide.

Although sheet 53b has been used as an upper lid in the above embodiment, a battery element may be housed by using a tray similar to tray 54 as an upper lid.

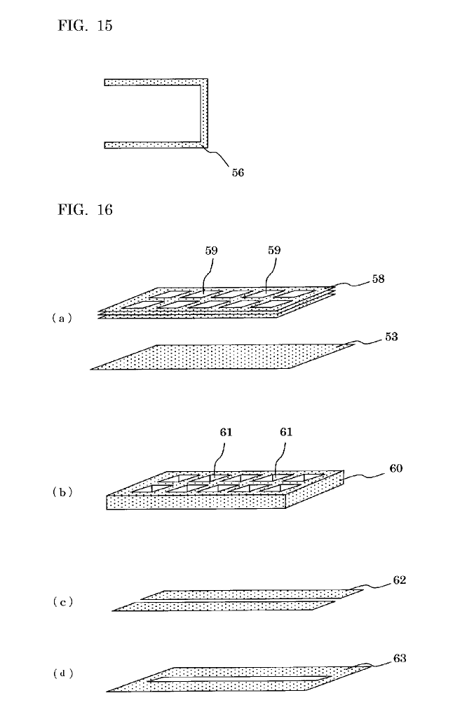

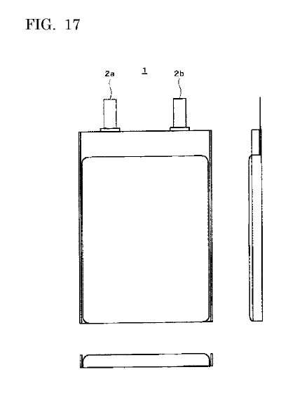

In addition, tray 54 may be formed by interleaving a metal frame between frame-like sheets 52 each other. As shown in FIG. 14, it is preferred that a width of the metal frame 55 is the same as or smaller (the inside aperture is larger) than frame-like sheet 52.

Furthermore, a box-like container, in which one side has been opened in advance, may be formed by using a plurality of the frame-like sheets 56 having only three sides as shown in FIG. 15 and two of sheets 53. After housing a battery element, the opened face may be bonded with thermo-compression to provide edge sealing.

Furthermore, FIG. 16 shows an embodiment of a packaging having a multi tray shape. A single tray has been formed in the embodiments of FIG. 12 to FIG. 15. Whereas, in this embodiment, multi-frame sheet 58, which has a plurality of apertures 59 each corresponding to one tray as shown in FIG. 16(a), is formed in a similar manner to the embodiment of the above-mentioned single tray, for example, by cutting a film having a structure of {thermo-compression bondable PI (Layer a)/heat resistant PI (Layer b)/thermo-compression bondable PI (Layer a)}. The multi-tray 60 shown in FIG. 16(b) may be produced by overlaying a plurality of multi-frame sheets 58 on sheet 53 (the same as that mentioned before) and bonding them with thermo-compression. Each battery element is placed in each battery housing portion 61 of this multi-tray 60, and another single sheet 53 is bonded with thermo-compression as an upper lid, whereby completing the formation of a lithium ion secondary battery in which a plurality of batteries is housed.

Since in this figure the array is two by five, the leading electrodes may be drawn toward the front side for batteries housed in trays of the front side column, and the leading electrodes may be drawn toward the back side for batteries housed in trays of the back side column. In addition, the leading electrodes may be drawn toward any direction by altering the shape of a sheet of an upper lid. For example, if sheet 62 or sheet 63 shown in FIGS. 16(c) and (d) is used, the leading electrodes may be drawn toward the front side even for the batteries housed in trays of the back side column.

Furthermore, a sheet to become an upper lid may be bonded with thermo-compression after connecting batteries housed in a multi-tray in series and/or parallel.

For the temperature capable of thermo-compression bonding of the thermo-compression bondable polyimide and the thermo-compression bondable polyimide, such a temperature may be selected that can achieve excellent bonding with aid of pressure. It is, for example, a temperature range where a thermo-compression bondable polyimide and a metal foil are affixed together, and preferably in a range from a temperature higher than a glass transition temperature by 20° C., more preferably in a range from a temperature higher than a glass transition temperature by 30° C., and particularly preferably in a range from a temperature higher than a glass transition temperature by 50° C., each up to 400° C. or lower.

When a thermo-compression bondable polyimide is bonded with a leading electrode (for example, leading electrode 32a and/or leading electrode 32b), other fusion bonding resins, thermo-compression bondable resins, thermosetting resins and the like may be used between the thermo-compression bondable polyimide and the leading electrode for the purpose of improving adhesion.

As mentioned above, the packaging of the present invention is not limited to a lithium ion secondary battery (including a lithium polymer ion secondary battery); it can also be applied to a variety of electrochemical devices. In addition to a lithium ion secondary battery, the electrochemical devices to which the present invention is applied include a primary battery such as a manganese dry battery, an alkaline manganese dry battery, a nickel-based primary battery, an oxyride battery, a silver oxide battery, a mercury battery, a zinc air battery, a lithium battery or a seawater battery, a secondary battery such as a lead storage battery, a nickel-hydrogen storage battery, a nickel-cadmium storage battery or a sodium-sulfur battery, an electric double layer capacitor, a dye-sensitized solar cell, and the like.

Among them it is preferred to apply to an electrochemical device using a non-aqueous electrolytic solution, for which especially moisture contamination will become a problem, and typical preference is given to a lithium ion secondary battery (including a lithium polymer ion secondary battery) and an electric double layer capacitor.

In addition, an electrochemical device element means a portion in which a packaging and a leading electrode are excluded from an electrochemical device. In the case of a battery or a capacitor, the electrochemical device element means an electric power generating element or an electric storage element involved in an electrochemical reaction such as discharge and/or electric storage. In the case of a battery, known battery constitutions such as a positive electrode, a negative electrode, an electrolytic solution or a solid electrolyte, a separator, and the like are included.

The packaging structure of the present invention can be applied not only to an electrochemical device but also to other electronic and electric components.

### <Representative Properties of a Laminate>

Finally, a representative production example of a laminate and properties thereof will be shown.

### Reference Example 1

### Production Example of a Thermo-Compression Bondable Multilayer Polyimide Film

### (Production of a Dope for a Heat Resistant Polyimide)

Into N, N-dimethylacetamide, paraphenylenediamine (PPD) and 3,3′,4,4′-biphenyltetracarboxylic dianhydride (s-BPDA) were added in a molar ratio of 1,000:998 so that a monomer concentration became 18% (% by weight, hereinafter the same shall apply), and the resulting mixture was reacted for 3 hours at 50° C. A solution viscosity of the obtained polyamic acid solution at 25° C. was about 1,680 poises.

### (Production of a Dope for a Thermo-Compression Bondable Polyimide)

Into N,N-dimethylacetamide, 1,3-bis(4-aminophenoxy)benzene (TPE-R), 2,3,3′,4′-biphenyltetracarboxylic dianhydride (a-BPDA) and 3,3′,4,4′-biphenyltetracarboxylic dianhydride (s-BPDA) were added in a molar ratio of 1,000:200:800 so that a monomer concentration became 18%, and triphenyl phosphate was also added in 0.5% by weight relative to the monomer weight, and the resulting mixture was reacted for 3 hours at 40° C. A solution viscosity of the obtained polyamic acid solution at 25° C. was about 1,680 poises.

### (Production of a Thermo-Compression Bondable Multilayer Polyimide Film)

The dope for heat resistant polyimide and the dope for thermo-compression bondable polyimide prepared above were flow-casted on a metal support by using a film-forming equipment provided with a three-layer extrusion die (multi-manifold type die) and continuously dried under hot air at 140° C. to form a self-supporting film. After peeling off this self-supporting film from the support, the solvent was removed by gradually heating from 150° C. to 450° C. in a heating furnace, and imidization was carried out, and the resulting long three-layer polyimide film was wound onto a wind-up roll. The resulting three-layer polyimide film (layer constitution: thermo-compression bondable polyimide (Layer a)/heat resistant polyimide (Layer b)/thermo-compression bondable polyimide (Layer a)) were evaluated.

### (Properties of a Thermo-Compression Bondable Multilayer Polyimide Film)

Thickness constitution: 4 μm/17 μm/4 (total 25 μm)
Glass transition temperature of thermo-compression bondable polyimide (Layer a): 240° C.
Glass transition temperature of heat resistant polyimide (Layer b): not less than 300° C. and no definite temperature could be identified.
Linear expansion coefficient (from 50 to 200° C.): MD 19 ppm/° C., TD 17 ppm/° C.
Mechanical properties (Testing method: ASTM D882)
1) Tensile strength: MD, TD 520 MPa
2) Elongation percentage: MD, TD 100%
3) Tensile modulus: MD, TD 7,100 MPa
Electrical property (Testing method: ASTM D149)
1) Dielectric breakdown voltage: 7.2 kV

### (Production of a Laminate Consisting of Thermo-Compression Bondable Multilayer Polyimide Film/Metal (Aluminum Foil)/Thermo-Compression Bondable Multilayer Polyimide Film)

The above-described thermo-compression bondable multilayer polyimide film, an aluminum foil and the above-described thermo-compression bondable multilayer polyimide film are overlaid into three-layers in this order and preheated in a state without pressure for 30 seconds at 230° C. immediately before thermal pressing, after which the thermal pressing (heating temperature: 330° C., pressure: 2.3 MPa, compression bonding time: 5 minutes) was carried out, and the resultant product was cooled and taken out to produce a laminate.

As mentioned above, the laminate having the metal layer and the thermo-compression bondable polyimide layer is excellent in mechanical strength even at a high temperature and a low temperature, and furthermore also excellent, as is well known, in heat resistance, flame retardancy and durability. Therefore, the laminate is suitable for a packaging for electrochemical devices such as a battery to be used under a severe condition.

### (Production of a Bag Product)

In a similar manner to the explanations shown in FIG. 4 to FIG. 6, the laminate (the above described laminate was used) was folded, and the thermal pressing (heating temperature; 330° C., pressure; 2.3 MPa, pressure-bonding time: 5 minutes) was carried out while using Upilex S (which is product name; made by Ube Industries, Ltd., thickness 25 μm) as a spacer for an area not to be bonded. After the thermal pressing, the spacer was taken out to produce a bag product, in which one side was open and three sides were bonded by thermo-compression bonding. The bag product is excellent in heat resistance and flame retardancy.

Physical property evaluations were carried out in according with the following methods.
1) Glass transition temperature (Tg) of polyimide film: it was determined from the peak value of tans by a dynamic viscoelastic method (tensile method, frequency 6.28 rad/second, temperature rise rate 10° C./minute).
2) Linear expansion coefficient (from 50 to 200° C.) of polyimide film; an average linear expansion coefficient at 20 to 200° C. was measured by a TMA method (tensile method, temperature rise rate 5° C./minute).
3) Mechanical properties of polyimide film
Tensile strength; it was measured in accordance with ASTM D882 (crosshead speed 50 mm/minute).
Elongation percentage: it was measured in accordance with ASTM D882 (crosshead speed 50 mm/minute).
Tensile modulus: it was measured in accordance with ASTM D882 (crosshead speed 5 mm/minute).

### INDUSTRIAL APPLICABILITY

The packaging of the present invention is useful for an electrochemical device such as a battery.

### DESCRIPTION OF THE REFERENCE NUMERALS

10 Laminate

11 Metal layer

12 Thermo-compression bondable polyimide layer

12a Thermo-compression bondable polyimide

12b Heat resistant polyimide

13 Outer layer

15 Surface to become the inner surface of the packaging

21 Thermo-compression bonded portion

22 Spacer

23, 24, 25 Thermo-compression bonded portion

31 Battery element

32a, 32b Leading electrode

33 Packaging

34, 34a, 34b Opening portion

35 Lithium ion secondary battery

41 Lower tray

42 Upper tray

43 Flange portion

51 Thermo-compression bondable polyimide film

52 Frame-like sheet

53, 53b Sheet

54 Tray

55 Metal frame

56 Frame-like sheet

58 Multi-frame sheet

59 Opening

60 Multi-tray

61 Battery housing portion

62 Sheet (Upper lid)

63 Sheet (Upper lid)

1-12. (canceled)

13. A packaging for an electrochemical device, wherein
the packaging is formed by using a laminate having a metal layer and a thermo-compression bondable polyimide layer, and
the packaging is in a form of a hermetically packed structure in which the thermo-compression bondable polyimide layer is bonded by thermo-compression at a periphery of the laminate.

14. A packaging according to claim 13, wherein the packaging is in a form of the hermetic structure such that the laminate is overlaid so that the thermo-compression bondable polyimide layer is placed inside and the thermo-compression bondable polyimide layer is bonded by thermo-compression at a periphery of the laminate.

15. A packaging according to claim 14, wherein the hermetic structure is in a form of a hermetic bag structure or a hermetic tray structure.

16. A packaging according to claim 13, wherein the thermo-compression bondable polyimide layer is formed by a material capable of thermo-compression bonding within a range from 150° C. to 400° C.

17. A packaging according to claim 13, wherein the thermo-compression bondable polyimide layer comprising a multilayer structure including a thermo-compression bondable polyimide and a heat resistant polyimide.

18. A packaging according to claim 17, wherein the heat resistant polyimide is a polyimide obtained from a combination comprising 3,3′,4,4′-biphenyltetracarboxylic dianhydride and p-phenylenediamine.

19. An electrochemical device comprising,
the packaging according to claim 13, and
an electrochemical device element hermetically housed inside of the packaging.

20. An electrochemical device according to claim 19, which is a lithium ion secondary battery.

21. A method of producing an electrochemical device comprising an electrochemical device element and a packaging enclosing the electrochemical device element, the method comprising the steps of:
providing a laminate having a metal layer and a thermo-compression bondable polyimide layer, and
forming the packaging by heat-bonding the thermo-compression bondable polyimide layer of the laminate at a periphery to form a hermetically packed structure so that the electrochemical device element is housed inside.

22. A method of producing an electrochemical device according to claim 21, wherein the packaging is formed into the hermetically packed structure by overlaying the laminate so that the thermo-compression bondable polyimide layer is placed inside, and performing thermo-compression bonding of the thermo-compression bondable polyimide layer at a periphery of the laminate.

23. A method of producing an electrochemical device according to claim 22, wherein the packaging is formed so that the hermetically packed structure is in a form of a hermetic bag structure or a hermetic tray structure.

24. A method of producing an electrochemical device according to claim 21, comprising performing thermo-compression bonding the thermo-compression bondable polyimide layer by applying pressure while heating in a range from 150° C. to 400° C.
